(19) United States
(12) Patent Application Publication
(10) Pub. No.: US 2012/0136660 A1
(43) Pub. Date: May 31, 2012

(54) VOICE-ESTIMATION BASED ON REAL-TIME PROBING OF THE VOCAL TRACT

(75) Inventors: Dale D. Harman, Freehold, NJ (US); Lothar Benedikt Moeller, Middletown, NJ (US)

(73) Assignee: ALCATEL-LUCENT USA INC., Murray Hill, NJ (US)

(21) Appl. No.: 12/956,552

(22) Filed: Nov. 30, 2010

(51) Int. Cl. G10L 15/04

(52) U.S. Cl. 704/254; 704/E15.005

(57) ABSTRACT

A voice-estimation device that probes the vocal tract of a user with sub-threshold acoustic waves to estimate the user's voice while the user speaks silently or audibly in a noisy or socially sensitive environment. The waves reflected by the vocal tract are detected and converted into a digital signal, which is then processed segment-by-segment. Based on the processing, a set of formant frequencies is determined for each segment. Each such set is then analyzed to assign a phoneme to the corresponding segment of the digital signal. The resulting sequence of phonemes is converted into a digital audio signal or text representing the user's estimated voice.

### BACKGROUND

1. Field of the Invention

The present invention relates to communication equipment and, more specifically but not exclusively, to voice-estimation devices and communication systems employing the same.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Although the use of cell phones has been rapidly proliferating over the last decade, there are still circumstances in which the use of a conventional cell phone is not physically feasible and/or socially acceptable. For example, a relatively loud background noise in a nightclub, disco, or flying aircraft might cause the speech addressed to a remote party to become inaudible and/or unintelligible. Also, having a cell-phone conversation during a meeting, conference, movie, or performance is generally considered to be rude and, as such, is not normally tolerated. Today's response to most of these situations is to turn off the cell phone or, if physically possible, leave the noisy or sensitive area to find a better place for a phone call.

### SUMMARY

Disclosed herein are various embodiments of a voice-estimation (VE) device that probes the vocal tract of a user with sub-threshold acoustic waves to estimate the user's voice while the user speaks silently or audibly in a noisy or socially sensitive environment. The waves reflected by the vocal tract are detected and converted into a digital signal, which is then processed, segment-by-segment. Based on the processing, a set of formant frequencies is determined for each segment. Each such set is then analyzed to assign a phoneme to the corresponding segment of the digital signal. The resulting sequence of phonemes is converted into a digital audio signal or text representing the user's estimated voice.

Advantageously, certain embodiments of the VE device do not rely on training procedures to become operational, and the speech synthesis implemented therein is not language sensitive. In addition, due to the fact that phoneme calculations rely mostly on the instant reflected impulse response and do not depend on the earlier or later sampling of the vocal tract, speech synthesis can be carried out with a relatively small processing delay, which provides for a more-natural flow of conversation than that enabled by comparable prior-art devices, e.g., those relying on reference-signal libraries for speech synthesis.

According to one embodiment, provided is an apparatus having a speaker for directing an excitation signal into a vocal tract and a microphone for detecting a vocal-tract response signal corresponding to the excitation signal. The apparatus further has a digital signal processor operatively coupled to the microphone and configured to process a segment of the response signal to determine a corresponding set of one or more formant frequencies for the vocal tract and further process the set of formant frequencies to identify a phoneme corresponding to the segment.

According to another embodiment, provided is a digital signal processor for being operatively coupled to a speaker configured to direct an excitation signal into a vocal tract and to a microphone configured to detect a vocal-tract response signal corresponding to the excitation signal. The processor is configured to process a segment of the response signal to determine a corresponding set of one or more formant frequencies for the vocal tract and further process the set of formant frequencies to identify a phoneme corresponding to the segment.

According to yet another embodiment, provided is a method of synthesizing speech having the steps of: directing an excitation signal generated by a speaker into a vocal tract; detecting, with a microphone, a vocal-tract response signal corresponding to the excitation signal; processing a segment of the response signal to determine a corresponding set of one or more formant frequencies for the vocal tract; and processing the set of formant frequencies to identify a phoneme corresponding to the segment.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of a communication system according to one embodiment of the invention;

FIG. 2 shows a block diagram of a drive circuit that can be used in the communication system shown in FIG. 1 according to one embodiment of the invention; and

FIGS. 3A-3B show block diagrams of a processor that can be used in the communication system shown in FIG. 1 according to one embodiment of the invention.

### DETAILED DESCRIPTION

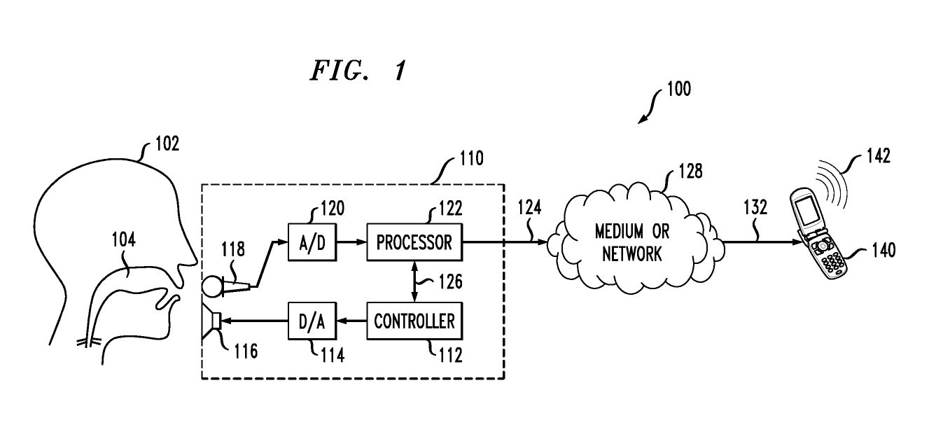

FIG. 1 shows a block diagram of a communication system 100 according to one embodiment of the invention. System 100 has a voice-estimation (VE) subsystem 110 that can be used, e.g., to detect silent speech or to enhance the perception of normal speech when it is superimposed onto or substantially overwhelmed by a relatively noisy acoustic background. The phenomenon of silent speech is explained in more detail, e.g., in U.S. Patent Application Publication No. 2010/0131268, which is incorporated herein by reference in its entirety.

Briefly, silent speech is a phenomenon in which the machinery of the vocal tract is activated in a normal manner, except that the vocal folds (also often referred to as vocal cords) are not being forced to oscillate. In general, the vocal folds will not oscillate if the pressure differential across the larynx (or sub-glottal pressure) is not sufficiently large. A person can activate the machinery of the vocal tract when she speaks to herself, i.e., “speaks” without producing a sound or by producing a sound that is below the physiological-perception threshold. By going through a mental act of “speaking to oneself,” a person subconsciously causes the brain to send appropriate signals to the muscles that control various articulators in the vocal tract while preventing the vocal folds from oscillating. It is well known that an average person is capable of silent speech with very little training or no training at all. Silent speech is different from whisper, which has sounds above the physiological-perception threshold.

VE subsystem 110 relies on sub-threshold acoustics (STA) to probe, in real time, the shape of the vocal tract 104 of a user 102. As used herein, the term “sub-threshold acoustics” or “STA” encompasses (i) sound waves from the human audio-frequency range (e.g., between about 15 Hz and about 20 kHz) whose intensity is below a physiological-perception threshold (i.e., imperceptible to the human ear due to the low intensity of the wave) and (ii) ultrasound waves (i.e., quasi-audio waves whose frequency is higher than the upper boundary of the human audio-frequency range, e.g., higher than about 20 kHz).

VE subsystem 110 has an STA speaker 116 and an STA microphone 118 that can be positioned near the entrance to vocal tract 104 (e.g., the mouth of person 102). STA speaker 116 operates under the control of a controller 112 and is configured to emit short (e.g., shorter than about 1 ms) bursts of STA waves for probing the shape of vocal tract 104. In a representative configuration, a burst of STA waves generated by STA speaker 116 enters vocal tract 104 through the mouth of user 102 and undergoes multiple reflections within the various cavities of the vocal tract. The reflected STA waves are detected by STA microphone 118 and the resulting electrical signal is converted into digital form and applied to a digital signal processor 122 for processing and analyses. A digital-to-analog (D/A) converter 114 and an analog-to-digital (A/D) converter 120 provide an appropriate interface between (i) controller 112 and processor 122, both of which operate in the digital domain, and (ii) STA speaker 116 and STA microphone 118, both of which operate in the analog domain. Controller 112 and processor 122 may use a digital-signal bus 126 to aid one another in the generation of drive signals for STA speaker 116 and the deconvolution of the response signals detected by STA microphone 118.

Based on the signals generated by STA microphone 118, processor 122 produces an estimated-voice signal 124 corresponding to the silent or noise-burdened speech of user 102. In one embodiment, estimated-voice signal 124 comprises a sequence of phonemes corresponding to the voice of user 102. In another embodiment, estimated-voice signal 124 comprises a digital audio signal that can be used to produce a regular perceptible sound corresponding to the voice of user 102.

As used herein, the term “phoneme” refers to a smallest unit of potentially meaningful sound within a given language's system of recognized sound distinctions. Each phoneme in a language acquires its identity by contrast with other phonemes for which it cannot be substituted without potentially altering the meaning of a word. For example, recognition of a difference between the words “level” and “revel” indicates a phonemic distinction in the English language between /l/ and /r/ (in transcription, phonemes are indicated by two slashes). Unlike a speech phone, a phoneme is not an actual sound, but rather, is an abstraction representing that sound.

As used herein, the term “speech phone” refers to a basic unit of speech revealed via phonetic speech analysis and possessing distinct physical and/or perceptual characteristics. For example, each of the different vowels and consonants used to convey human speech is a speech phone. As explained in the above-referenced U.S. Patent Application Publication No. 2010/0131268, the vocal-tract configuration corresponding to a speech phone spoken silently is substantially the same as the vocal-tract configuration corresponding to the same speech phone spoken audibly, except that, during the silent speech, the vocal folds are not vibrating.

In one embodiment, VE subsystem 110 is a part of a transceiver (e.g., a cell phone; not explicitly shown in FIG. 1) and is connected, in a conventional manner, to a wireless, wireline, and/or optical transmission system, network, or medium (cloud) 128. Cloud 128 transmits estimated-voice signal 124 to a remote transceiver (e.g., cell phone) 140. Transceiver 140 processes a received signal 132 that carries estimated-voice signal 124 and converts it into a sound 142 that phonates the estimated-voice signal. In an alternative embodiment, transceiver 140 can convert estimated-voice signal 124 into text and then display the text on a display screen in addition to or instead of the estimated-voice signal being played as sound 142.

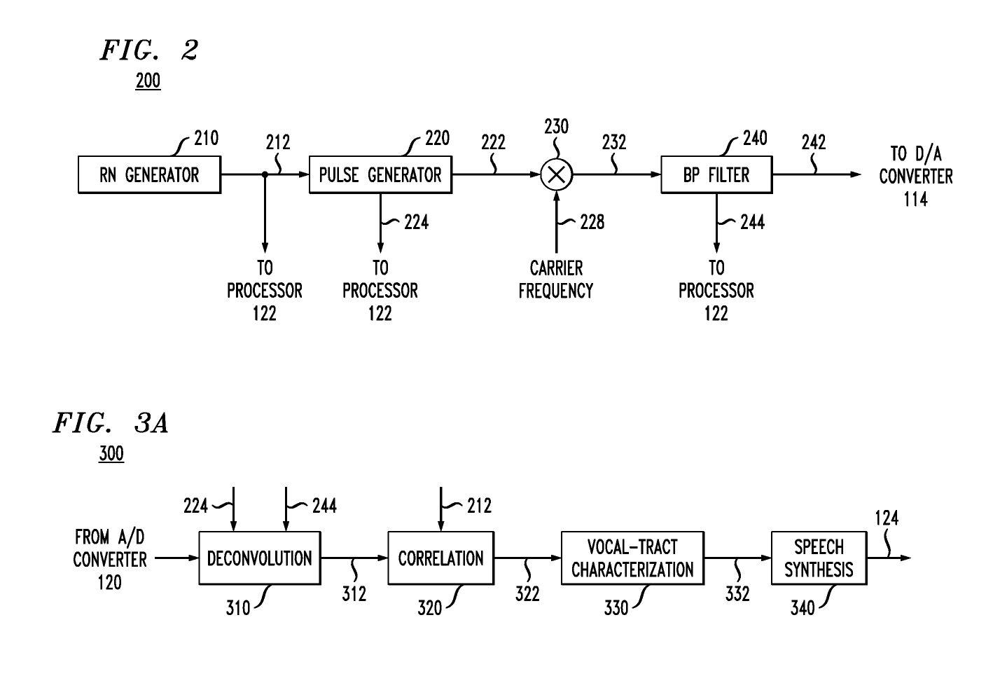

FIG. 2 shows a block diagram of a drive circuit 200 that can be used in controller 112 according to one embodiment of the invention. Drive circuit 200 generates a digital drive signal 242 that is used to excite STA speaker 116 in a manner that enables processor 122 to keep track of the changing acoustic characteristics of vocal tract 104 during normal or silent speech (see FIG. 1). To enable VE subsystem 110 (FIG. 1) to appropriately probe the configuration (shape) of vocal tract 104 during a speech phone, drive circuit 200 generates digital drive signal 242 based on a pseudo-random bit sequence 212 produced by a random-number (RN) generator 210. RN generator 210 applies bit sequence 212 to a digital pulse generator 220 and also provides a copy of the bit sequence to processor 122. In one embodiment, RN generator 210 may be part of processor 122 or a separate component.

In one implementation, bit sequence 212 may have about five hundred or one thousand bits, with a bit period of about 10 μs. In an alternative implementation, bit sequence 212 may be significantly longer than one thousand bits, e.g., two or five thousand bits. One skilled in the art will appreciate that a sufficiently long bit sequence 212 will generate an excitation spectrum that more accurately approximates a continuous spectrum than a relatively short bit sequence 212. Having a continuous excitation spectrum may be advantageous, e.g., when a relatively sharp acoustic resonance of vocal tract 104 needs to be detected. More specifically, the relatively closely spaced comb lines of a relatively long bit sequence 212 make it less probable that a sharp resonance falls between two adjacent comb lines and remains undetected by VE subsystem 110.

Digital pulse generator 220 converts bit sequence 212 into a pulse sequence 222. Pulse sequence 222 may have (i) an excitation pulse for each “one” of bit sequence 212 and (ii) no excitation pulse for each “zero” of the bit sequence. Alternatively, pulse sequence 222 may have (i) a positive excitation pulse for each “one” of bit sequence 212 and (ii) a negative excitation pulse for each “zero” of the bit sequence. Each excitation pulse in pulse sequence 222 can have any suitable shape (envelope), such as a Gaussian or rectilinear shape, which is communicated to processor 122 (FIG. 1) via signal 224.

A multiplier 230 injects a carrier-frequency signal 228 into the excitation-pulse envelopes of pulse sequence 222 to generate an unfiltered digital drive signal 232. In various configurations, the carrier frequency can be selected, e.g., from a range between about 1 kHz and about 100 kHz. A digital band-pass (BP) filter 240 generates digital drive signal 242 by subjecting signal 232 to appropriate band-pass filtering. For example, if an ultrasonic carrier frequency is used, then the band-pass filtering implemented in filter 240 removes possible signal components located in the human audio-frequency range because such components may be audible to user 102 (FIG. 1). The spectral shape of the pass band imposed by filter 240 onto signal 232 is communicated to processor 122 (FIG. 1) via signal 244. Digital drive signal 242 is digital-to-analog converted in D/A converter 114, and the resulting analog signal is applied to STA speaker 116, as indicated in FIG. 1. Signals 212, 224, and 244 are transmitted via signal bus 126 (FIG. 1).

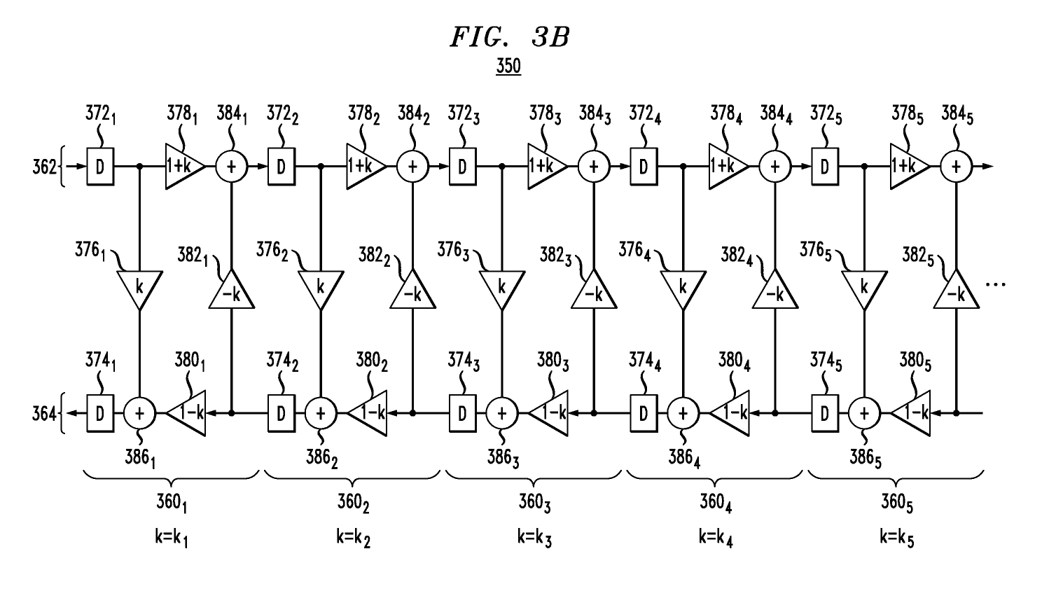

FIGS. 3A-3B show block diagrams of a processor 300 that can be used as processor 122 (FIG. 1) according to one embodiment of the invention. More specifically, FIG. 3A shows an overall block diagram of processor 300. FIG. 3B shows a vocal-tract model 350 implemented in a vocal-tract-characterization (VTC) module 330 of processor 300.

The processing implemented in a deconvolution module 310 and a correlation module 320 serves to determine a reflected impulse response of vocal tract 104. As used herein, the term “impulse response” refers to an STA echo signal produced by vocal tract 104 in response to a single very short STA excitation pulse applied to the vocal tract by STA speaker 116. Mathematically, an ideal excitation pulse that produces an ideal impulse response is described by the Dirac delta function for continuous-time systems or by the Kronecker delta for discrete-time systems. Since the excitation pulses used in VE subsystem 110 are not ideal, e.g., due to the finite width of the excitation-pulse envelope imposed by pulse generator 220 and/or the band-pass filtering imposed by BP filter 240 (see FIG. 2), a digital input signal 302 received by processor 300 from STA microphone 118 and A/D converter 120 (FIG. 1) is deconvolved in deconvolution module 310 to digitally remove the effects of the excitation-pulse envelope and band-pass filtering on the STA echo signal. In the deconvolution process, deconvolution module 310 uses the known envelope shape of the actual excitation pulses, which is communicated to the deconvolution module via signal 224, and the spectral characteristics of band-pass filter 240, which are communicated to the deconvolution module via signal 244 (also see FIG. 2).

A deconvolved digital signal 312 produced by deconvolution module 310 is a superposition of the voice-tract responses corresponding to multiple excitation pulses of pulse sequence 222 (FIG. 2). Correlation module 320 functions to determine the “true” reflected impulse response of vocal tract 104 by correlating signal 312 with the original bit sequence 212 used in the generation of pulse sequence 222. The reflected impulse response determined by deconvolution module 310 is provided to VTC module 330 via digital signal 322. One skilled in the art will appreciate that the processing implemented in correlation module 320 may be similar to that used in a receiver of a direct-sequence spread-spectrum (DSSS) communication system. Representative examples of such processing are described, e.g., in U.S. Pat. Nos. 7,643,535, 7,324,582, and 7,088,766, all of which are incorporated herein by reference in their entirety. Additional useful techniques that can be applied to implement the signal processing performed in drive circuit 200 and deconvolution module 310 are disclosed, e.g., in the paper by M. R. Schroeder, entitled “Integrated-Impulse Method Measuring Sound Decay without Using Impulses,” published in J. Acoust. Soc. Am, 1979, v. 66(2), pp. 497-500, which paper is incorporated herein by reference in its entirety.

VTC module 330 uses the reflected impulse response received via signal 322 to determine acoustic characteristics of vocal tract 104 in the audio-frequency range (e.g., in a frequency range between 15 Hz and 20 kHz). More specifically, VTC module 330 treats vocal tract 104 as a waveguide that has varying impedance along its length. As known in the art, impedance variations and discontinuities cause a wave that propagates along a waveguide to be partially reflected back. Therefore, the impedance profile of the waveguide can be determined by modeling the reflected impulse response of the waveguide as a superposition of multiple reflected waves caused by the impedance variations/discontinuities along the length of the waveguide. If necessary, the impedance profile can be converted into a geometric shape that represents the actual geometry of vocal tract 104 at that time.

Referring to FIG. 3B, model 350 represents vocal tract 104 as a plurality of serially connected constant-impedance stages 360₁, each characterized by a corresponding constant impedance value, where i=1, 2, 3, . . . N. In general, the larger the N value, the higher the computational-power requirements for VTC module 330. In a representative implementation, N is between 5 and 50.

Each stage 360ᵢ has a forward-propagation path and a backward-propagation path. In FIG. 3B, the forward-propagation paths of different stages 360 line up to form an upper branch 362 and have signal arrows pointing to the right. The backward-propagation paths of different impedance stages 360 similarly line up to form a lower branch 364 and have signal arrows pointing to the left.

The forward-propagation path of stage 360ᵢ includes a delay element 372ᵢ that represents the length of the corresponding constant-impedance section in vocal tract 104. The backward-propagation path of stage 360ᵢ includes a similar delay element 374ᵢ. In an alternative vocal-tract model, the delay introduced by element 372ᵢ is increased by a factor of two while delay element 374ᵢ is removed.

Four amplifiers/attenuators 376ᵢ, 378ᵢ, 380ᵢ, and 382ᵢ and two adders 384ᵢ and 386ᵢ model the impedance discontinuity between stages 360ᵢ and 360ᵢ₊₁. The amplification/attenuation coefficients introduced by each of amplifiers/attenuators 376ᵢ, 378ᵢ, 380ᵢ, and 382ᵢ are indicated in FIG. 3B, with reflection coefficient kᵢ given by Eq. (1):

$${k}_{i} = \frac{{A}_{i} - {A}_{i + 1}}{{A}_{i} + {A}_{i + 1}} \qquad ( 1 )$$

where Aᵢ is the cross-sectional area of the i-th constant-impedance section in vocal tract 104, and A_{N+1}=0. Adder 384ᵢ serves to sum (i) a portion of the forward-propagating wave that has passed the impedance discontinuity without being reflected back and (ii) a portion of the backward-propagating wave that has been reflected from the impedance discontinuity. Adder 386ᵢ similarly serves to sum (i) a portion of the forward-propagating wave that has been reflected by the impedance discontinuity and (ii) a portion of the backward-propagating wave that has passed the impedance discontinuity without being reflected back.

In one embodiment, VTC module 330 determines reflection coefficients kᵢ by recursively calculating the input and output signals of each stage 360ᵢ at various delay times and relating those signals to the reflected impulse response provided by signal 322. For example, reflection coefficient k₁ is calculated using the value of the reflected impulse response at time 2D. Then, the calculated value of k₁ is used to calculate the amplitude of the input signal applied by adder 384₁ to delay element 372₂ at time D. Reflection coefficient k₂ is calculated using (i) the value of the reflected impulse response at time 4D; (ii) the calculated amplitude of the input signal applied by adder 384₁ to delay element 372₂ at time D; and (iii) the calculated value of k₁. Then, the calculated values of k₁ and k₂ are used to calculate the amplitudes of the input signal applied by adder 384₂ to delay element 372₃ at time 2D and at time 4D. The calculated values of k₁ and k₂ are similarly used to calculate the amplitude of the input signal applied by delay element 374₂ to amplifiers attenuators 380₁ and 382₁ at time 3D. Reflection coefficient k₃ is calculated using (i) the value of the reflected impulse response at time 6D; (ii) reflection coefficients k₁ and k₂; and (iii) various signal amplitudes previously calculated for stages 360₁ and 360₂. The calculation advances in this manner from stage to stage until all reflection coefficients are determined. After the full set of reflection coefficients kᵢ is calculated, VTC module 330 provides this set, via a digital signal 332, to a speech-synthesis module 340.

One skilled in the art will appreciate that model 350 considers each stage 360 to be a single-mode waveguide. However, within certain frequency ranges, some stages 360 may support multimode signal propagation. Therefore, to improve the applicability and accuracy of model 350, various spatial-mode filter techniques may need to be applied in conjunction with model 350.

Speech-synthesis module 340 uses each set of reflection coefficients kᵢ received from VTC module 330 to determine a corresponding phoneme. In one embodiment, estimated-voice signal 124 generated by speech-synthesis module 340 comprises a sequence of phonemes that has been generated based on digital signal 332. In an alternative embodiment, estimated-voice signal 124 is a digital audio signal that has been generated by speech-synthesis module 340 by converting each phoneme into a corresponding audio-signal segment.

In one embodiment, speech-synthesis module 340 converts a set of reflection coefficients kᵢ received from VTC module 330 into a corresponding phoneme as follows.

First, speech-synthesis module 340 uses the set of reflection coefficients kᵢ to calculate a corresponding set of formant frequencies. As used herein, the term “formant” refers to an acoustic resonance of vocal tract 104. Since reflection coefficients kᵢ can be related to the cross-sectional profile of vocal tract 104 (see Eq. (1)), formant frequencies can be calculated in a relatively straightforward manner, e.g., as the resonant frequencies of the corresponding hollow shape.

Second, a subset of M formant frequencies is selected for further analysis using predetermined selection criteria. For example, in its most basic form, the subset may consist of the two lowest formant frequencies (i.e., M=2). Alternatively, the subset may include a first selected number of formant frequencies from a first audio band (e.g., below 4 kHz) and a second selected number of formant frequencies from a second audio band (e.g., between 15 kHz and 20 kHz), for a total number of M formant frequencies. Other alternative selection criteria may similarly be used.

Third, the selected subset of M formant frequencies is mapped onto a phoneme constellation. In one embodiment, the phoneme constellation consists of a plurality of constellation points or contiguous M-dimensional shapes in an M-dimensional frequency space, wherein each phoneme is represented by at least one distinct constellation point or contiguous M-dimensional shape. Based on the constellation mapping, each meaningful segment of signal 332 is converted into a corresponding phoneme.

For example, for a three-dimensional phoneme constellation (i.e., M=3), the mapping may be performed as follows. The frequency of the first selected formant is used as the first coordinate in the three-dimensional frequency space; the frequency of the second selected formant is used as the second coordinate in the three-dimensional frequency space; and the frequency of the third selected formant is used as the third coordinate in the three-dimensional frequency space. Next, the constellation point that is most proximate to the point having these three coordinates is identified. Finally, the phoneme corresponding to the identified constellation point is assigned to the corresponding speech segment of signal 332. This process is then repeated for the next segment of signal 332.

Various phoneme constellations for use in speech-synthesis module 340 may be generated using the following considerations. In general, formants represent the distinguishing frequency components of human speech. Most formants are produced by acoustic resonances in one or more of the following principal chambers of the vocal tract: (i) the pharyngeal cavity located between the esophagus and the epiglottis; (ii) the oral cavity defined by the tongue, teeth, palate, velum, and uvula; (iii) the labial cavity located between the teeth and lips; and (iv) the nasal cavity. The shapes of these cavities and, therefore, their acoustic properties are controlled by the positions of various articulators in the vocal tract, such as the velum, tongue, lips, jaws, etc. Most often, knowledge of the frequencies of the first two (i.e., lowest-frequency) formants is sufficient to disambiguate vowels. Nasals and consonants may require the use of more than two formants for their disambiguation. Plosives and, to some degree, fricatives modify the placement of formants in the surrounding vowels. Bilabial sounds (such as ‘b’ and ‘p’) cause a lowering of the formants in the surrounding vowels; velar sounds (such as ‘k’ and ‘g’) almost always show the second and third formants very close to each other; alveolar sounds (such as ‘t’ and ‘d’) cause less-systematic changes in neighboring vowel formants, depending partially on the vowel itself. These and other known characteristics of human speech may be used in the constellation-mapping techniques implemented in speech-synthesis module 340.

Advantageously, embodiments of the invention do not rely on complicated pattern-recognition procedures, in which STA echo signals need to be compared with and matched to reference echo responses (RERs) from a large database or library of such reference echo responses. Since no RER database or library is used, no VE training is required for VE subsystem 110 to be operational, and the speech synthesis is not language sensitive. Furthermore, due to the fact that phoneme calculations rely mostly on the instant reflected impulse response and do not depend on the earlier or later sampling of the vocal tract, speech synthesis can be carried out with a relatively small processing delay, which provides for a much more-natural flow of conversation than that enabled by VE systems that rely on complicated pattern-recognition techniques.

Various embodiments of VE subsystem 110 can advantageously be used to phonate silent speech produced (i) in a noisy or socially sensitive environment; (ii) by a disabled person whose vocal tract has a pathology due to a disease, birth defect, or surgery; and/or (iii) during a military operation, e.g., behind enemy lines. Alternatively or in addition, various embodiments of system 100 can advantageously be used to improve the perception quality of normal speech when it is burdened by ambient acoustic noise. For example, if the noise level is relatively tolerable, then VE subsystem 110 can be used as a supplementary means to enhance the voice signal produced by a conventional acoustic microphone. If the noise level is intermediate between relatively tolerable and intolerable, then the acoustic microphone can be used as a secondary means to enhance the quality of the estimated-voice signal generated by VE subsystem 110. If the noise level is intolerable, then the acoustic microphone can be turned off, and the speech signals can be generated solely based on the estimated-voice signal produced by VE subsystem 110.

While this invention has been described with reference to illustrative embodiments, this description is not intended to be construed in a limiting sense. For example, methods and approaches used in the DSSS technology, as applied to wireless communications, can be used in various alternative embodiments of controller 112 and/or processor 122 for fast, accurate, and computationally efficient determination of the impulse response of voice tract 104 (FIG. 1). Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

What is claimed is:

1. An apparatus, comprising:
a speaker for directing an excitation signal into a vocal tract;
a microphone for detecting a vocal-tract response signal corresponding to the excitation signal; and
a digital signal processor operatively coupled to the microphone and configured to:
process a segment of the response signal to determine a corresponding set of one or more formant frequencies for the vocal tract; and
further process the set of formant frequencies to identify a phoneme corresponding to the segment.

2. The apparatus of claim 1, wherein the apparatus is configured to convert into a digital audio signal a sequence of phonemes that is identified by the processor based on a plurality of segments of the response signal.

3. The apparatus of claim 1, wherein the apparatus is configured to convert into text a sequence of phonemes that is identified by the processor based on a plurality of segments of the response signal.

4. The apparatus of claim 1, further comprising a random-number generator, wherein:
the excitation signal comprises a sequence of excitation pulses that corresponds to a sequence of random numbers generated by the random-number generator; and
the processor uses said sequence of random numbers in the processing of the response signal.

5. The apparatus of claim 4, further comprising a controller operatively coupled to the speaker to apply thereto a drive signal that causes the speaker to generate the excitation signal, wherein the controller comprises:
a pulse generator for converting the sequence of random numbers into a corresponding sequence of pulse-envelope shapes;
a multiplier for injecting a carrier frequency into the pulse-envelope shapes; and
a band-pass filter for filtering a signal produced by the multiplier as a result of said injection, wherein a filtered signal produced by the band-pass filter is the drive signal.

6. The apparatus of claim 5, wherein:
the controller is operatively coupled to provide one or more parameters of the drive signal to the processor; and
the processor uses said one or more parameters in the processing of the detected response signal.

7. The apparatus of claim 6, wherein said one or more parameters comprise at least one of the carrier frequency, a pulse-envelope shape used by the pulse generator, and a spectral characteristic of the band-pass filter.

8. The apparatus of claim 5, wherein the carrier frequency is greater than about 20 kHz.

9. The apparatus of claim 5, wherein:
the carrier frequency is in a range between about 1 kHz and about 20 kHz; and
the pulse-envelope shapes have amplitudes that cause the excitation signal to have an intensity that is below a human physiological-perception threshold.

10. The apparatus of claim 4, wherein:
the processor correlates the segment of the response signal and a corresponding segment of the sequence of random numbers to determine a reflected impulse response of the vocal tract; and
the processor determines the set of formant frequencies based on the reflected impulse response.

11. The apparatus of claim 10, wherein:
the processor determines an impedance profile of the vocal tract based on the reflected impulse response; and
the processor determines the set of formant frequencies based on the impedance profile.

12. The apparatus of claim 11, wherein, for the determination of the impedance profile, the processor is configured to:
employ a model of the vocal tract according to which the vocal tract comprises a plurality of constant-impedance sections;
decompose the reflected impulse response into components corresponding to wave reflections from impedance discontinuities between adjacent constant-impedance sections; and
determine the impedance profile based on said decomposition.

13. The apparatus of claim 1, wherein:
the set comprises M formant frequencies, where M is an integer greater than one; and
for the identification of the phoneme corresponding to the segment, the processor is configured to map the M formant frequencies onto a phoneme constellation comprising a plurality of constellation points in an M-dimensional frequency space, wherein each phoneme is represented by at least one distinct constellation point.

14. The apparatus of claim 13, wherein M is different for different types of phonemes.

15. The apparatus of claim 1, wherein the response signal corresponds to silent speech.

16. The apparatus of claim 1, wherein the speaker, the microphone, and the signal processor are implemented in a cell phone.

17. An apparatus, comprising a digital signal processor for being operatively coupled to a speaker configured to direct an excitation signal into a vocal tract and to a microphone configured to detect a vocal-tract response signal corresponding to the excitation signal, wherein said processor is configured to:
process a segment of the response signal to determine a corresponding set of one or more formant frequencies for the vocal tract; and
further process the set of formant frequencies to identify a phoneme corresponding to the segment.

18. The apparatus of claim 17, further comprising a random-number generator, wherein:
the excitation signal comprises a sequence of excitation pulses that corresponds to a sequence of random numbers generated by the random-number generator;
the processor correlates the segment of the response signal and a corresponding segment of the sequence of random numbers to determine a reflected impulse response of the vocal tract; and
the processor determines the set of formant frequencies based on the reflected impulse response.

19. The apparatus of claim 18, wherein the processor determines an impedance profile of the vocal tract based on the reflected impulse response and then determines the set of formant frequencies based on the impedance profile, wherein, for the determination of the impedance profile, the processor is configured to:
employ a model of the vocal tract according to which the vocal tract comprises a plurality of constant-impedance sections;
decompose the reflected impulse response into components corresponding to wave reflections from impedance discontinuities between adjacent constant-impedance sections; and
determine the impedance profile based on said decomposition.

20. A method of synthesizing speech, comprising:
directing an excitation signal generated by a speaker into a vocal tract;
detecting, with a microphone, a vocal-tract response signal corresponding to the excitation signal;
processing a segment of the response signal to determine a corresponding set of one or more formant frequencies for the vocal tract; and
processing the set of formant frequencies to identify a phoneme corresponding to the segment.
